(19) United States
(12) Patent Application Publication
(10) Pub. No.: US 2017/0262907 A1
(43) Pub. Date: Sep. 14, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Toru NAKATANI, Kanagawa (JP)

(73) Assignee: FUJI XEROX CO., LTD., Tokyo (JP)

(21) Appl. No.: 15/254,289

(22) Filed: Sep. 1, 2016

(30) Foreign Application Priority Data
Mar. 9, 2016 (JP) 2016-045785

(51) Int. Cl. G06Q 30/04

(52) U.S. Cl. CPC G06Q 30/04; G06K 9/00442

(57) ABSTRACT

An information processing apparatus includes an acquisition unit, a collecting unit, and a transmitting unit. The acquisition unit acquires, from an information collection apparatus, information regarding multiple image processing apparatuses from which use information needs to be collected. The collecting unit collects use information for billing from the multiple image processing apparatuses. The transmitting unit transmits, to the information collection apparatus, the use information in accordance with an approval operation regarding the use information.

### CROSS-REFERENCE TO RELATED APPLICATIONS

This application is based on and claims priority under 35 USC 119 from Japanese Patent Application No. 2016-045785 filed Mar. 9, 2016.

### BACKGROUND

### Technical Field

The present invention relates to an information processing apparatus, an information processing method, and a non-transitory computer readable medium.

### SUMMARY

According to an aspect of the invention, there is provided an information processing apparatus including an acquisition unit, a collecting unit, and a transmitting unit. The acquisition unit acquires, from an information collection apparatus, information regarding multiple image processing apparatuses from which use information needs to be collected. The collecting unit collects use information for billing from the multiple image processing apparatuses. The transmitting unit transmits, to the information collection apparatus, the use information in accordance with an approval operation regarding the use information.

### BRIEF DESCRIPTION OF THE DRAWINGS

Exemplary embodiments of the present invention will be described in detail based on the following figures, wherein:

FIG. 1 is a diagram illustrating and for describing an example of a system configuration using a first exemplary embodiment;

FIG. 2 is a diagram of a conceptual module configuration about the example of the configuration of the first exemplary embodiment;

FIGS. 3A and 3B are diagrams illustrating and for describing examples of the system configuration using the present exemplary embodiment;

FIG. 4 is a diagram illustrating and for describing an example of a data structure of an image processing apparatus table;

FIG. 5 is a flowchart illustrating an example of a process according to the first exemplary embodiment;

FIG. 6 is a diagram illustrating and for describing an example of a process according to the first exemplary embodiment;

FIG. 7 is a diagram illustrating and for describing an example of the process according to the first exemplary embodiment;

FIG. 8 is a diagram of a conceptual module configuration about an example of the configuration of a second exemplary embodiment;

FIG. 9 is a diagram illustrating and for describing an example of a data structure of a transmission period table;

FIG. 10 is a flowchart illustrating an example of a process according to the second exemplary embodiment;

FIGS. 11A and 11B are diagrams illustrating and for describing an example of a process according to the second exemplary embodiment; and

FIG. 12 is a block diagram illustrating an example of a hardware configuration of a computer that realizes the present exemplary embodiments.

### DETAILED DESCRIPTION

In the following, an example of various types of exemplary embodiment for realizing the present invention will be described in accordance with the drawings.

### First Exemplary Embodiment

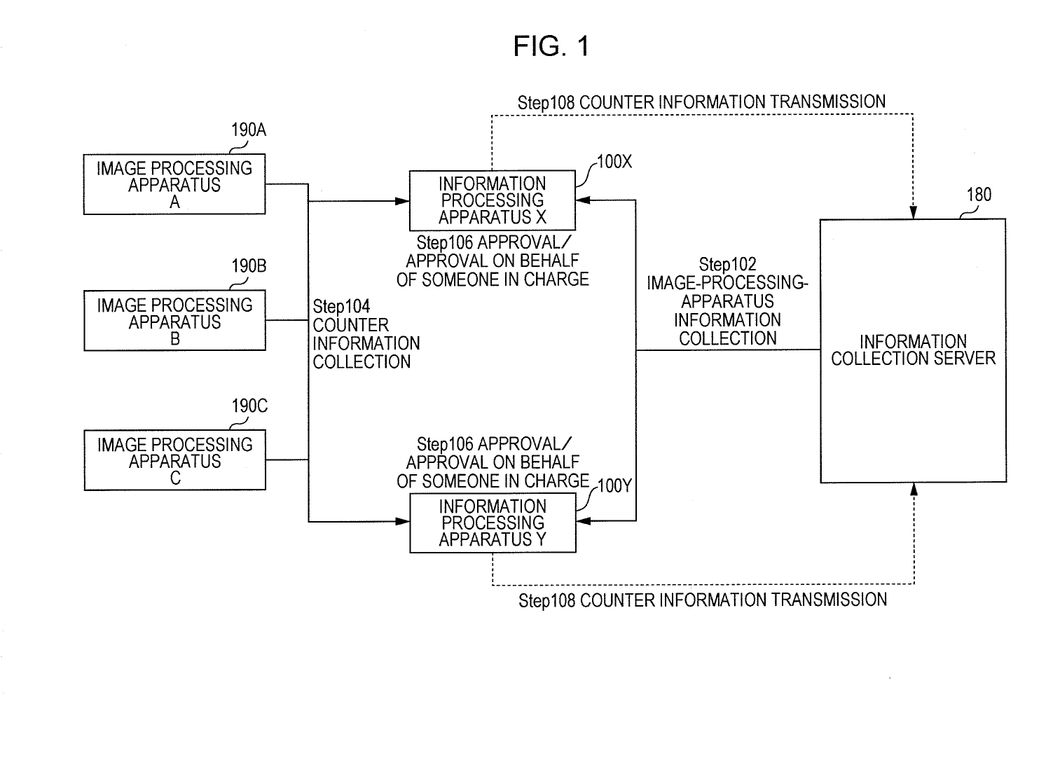

FIG. 1 is a diagram illustrating and for describing an example of a system configuration using a first exemplary embodiment.

Note that modules generally refer to parts that are logically separable such as software (computer programs), hardware, and the like. Thus, modules in the present exemplary embodiment refer not only to modules in a computer program but also modules in a hardware configuration. Thus, the present exemplary embodiment also describes computer programs that function as these modules (a program for causing a computer to execute each procedure, a program for causing the computer to function as each unit, and a program for causing the computer to realize each function), a system, and a method. Note that, for convenience's sake in terms of description, “store”, “cause . . . to store” and expressions similar thereto are used; however, in the case where an exemplary embodiment is a computer program, these expressions mean that “cause a storage device to store” or “performs control such that a storage device is caused to store . . . ”. There may be a one-to-one correspondence between modules and functions. When the modules are mounted, one module may be constituted by one program, or multiple modules may be constituted by one program. Alternatively, one module may be constituted by multiple programs. Moreover, multiple modules may be executed by one computer, or one module may be executed by multiple computers, which are computers in a distributed environment or a parallel processing environment. Note that one module may include another module. In addition, in the following, “connection” may be used not only for a physical connection but also for a logical connection (transmitting-receiving of data, instructions, a reference relationship between pieces of data, and the like). The term “predetermined” means that something is determined before a target process is performed, and also means that something is determined not only before a process according to the present exemplary embodiment starts but also after the process according to the present exemplary embodiment starts and before a target process starts, depending on a status or a state at that point in time or in accordance with a status or a state until that point in time. In the case where there are multiple “predetermined values”, the predetermined values may differ from one another or two or more of the predetermined values (as a matter of course, including all the predetermined values) may be the same. In addition, a description meaning “in the case of A, B is performed” is used to mean that “It is determined whether or not . . . is A. In the case where it is determined that . . . is A, B is performed”. Note that cases are excluded where a determination as to whether or not . . . is A is unnecessary.

In addition, a system or an apparatus may not only be constituted by multiple computers, hardware devices, apparatuses, and the like connected through a communication unit such as a network (including one-to-one correspondence communication connection) but also be realized using one computer, a hardware device, an apparatus, or the like. The terms “apparatus” and “system” are used as terms having the same meaning. As a matter of course, the term “system” does not include just a social “mechanism” (a social system), which is man-made arrangements.

For each process performed by each module or for each process in the case where multiple processes are performed in a module, target information is read from a storage device. After the process is performed, a processing result is written into the storage device. Thus, a description may be omitted as to reading of target information from the storage device before a process is performed and as to writing of target information into the storage device after the process is performed. Note that here the storage device may include a hard disk, a random access memory (RAM), an external storage medium, a storage device connected through a communication line, a register included in a central processing unit (CPU), and the like.

An information processing apparatus 100, which is the first exemplary embodiment, transmits use information collected from multiple image processing apparatuses 190 to an information collection server 180. As illustrated in the example of FIG. 1, the information processing apparatus 100 is connected to the image processing apparatuses 190 and the information collection server 180. Note that solid connection lines indicate the flow of information mainly from the information collection server 180, and dotted connection lines indicate the flow of information mainly from the image processing apparatuses 190.

Note that the example of FIG. 1 illustrates a case where there are two information processing apparatuses 100 (an information processing apparatus X: 100X, and an information processing apparatus Y: 100Y); however, there may be one information processing apparatus 100 or three or more information processing apparatuses 100.

The information processing apparatuses 100 are operated by persons in charge of the image processing apparatuses 190 (also referred to as administrators, persons who approve use information (approvers), or the like), and may be specifically personal computers (PCs), which may be desktop computers, notebook computers, tablet computers, or the like. In addition, for example, the information processing apparatuses 100 may communicate with the information collection server 180 and the image processing apparatuses 190 using a user interface with a browser function.

Each of the image processing apparatuses 190 may be a copier, a fax, a scanner, a printer, a multifunction machine (an image processing apparatus having two or more functions among a scanner, a printer, a copier, a fax, and the like), or the like. Use information regarding the image processing apparatus 190 is information for billing, and may be, for example, counter information indicating the number of printed sheets (the number of output sheets) (hereinafter, as an example, the counter information is described as the use information) in the case where the image processing apparatus 190 is a copier, a fax, a scanner, or a multifunction machine. In addition, in the case where the image processing apparatus 190 is a copier, a fax, a scanner, or a multifunction machine, the number of scanned sheets or the amount of space of a storage device used through scanning or the like may be treated as the use information, or a combination of the counter information and the amount of space used may be treated as the use information. Since this use information is information used for billing, an approval operation needs to be performed by a person in charge to transmit this use information to the information collection server 180.

The information collection server 180 is an apparatus that manages the image processing apparatuses 190, and needs, for each of the image processing apparatuses 190, for example use information regarding the image processing apparatus 190 to perform a billing process for use of the image processing apparatus 190. For example, the information collection server 180 is installed at a site on the side of a maker of the image processing apparatuses 190. As a specific example, bills are issued on the basis of collected counter information.

A schematic process (simply used as technical information that eases understanding of the technology) performed by an information processing apparatus 100 among the information processing apparatuses 100 will be described using the example illustrated in FIG. 1.

In Step 102, the information processing apparatus 100 collects image-processing-apparatus information from the information collection server 180.

In Step 104, the information processing apparatus 100 collects counter information from an image processing apparatus A: 190A, an image processing apparatus B: 190B, and an image processing apparatus C: 190C.

In Step 106, in accordance with an operation performed by a person in charge, the information processing apparatus 100 gives approval to the counter information or gives approval to the counter information on behalf of someone in charge. Giving approval on behalf of someone in charge means that the counter information regarding an image processing apparatus 190 of which a certain person is in charge is approved by another person.

In Step 108, the information processing apparatus 100 transmits, to the information collection server 180, the approved counter information or the counter information approved on behalf of someone in charge.

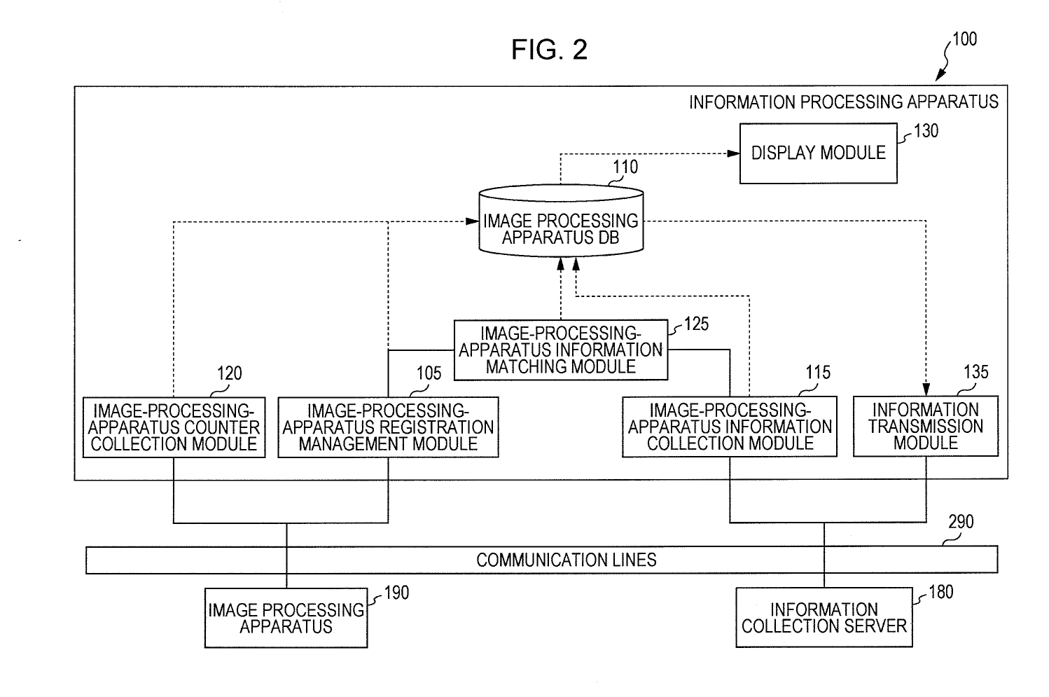

FIG. 2 is a diagram of a conceptual module configuration about the example of the configuration of the first exemplary embodiment.

The information processing apparatus 100 includes an image-processing-apparatus registration management module 105, an image processing apparatus database (DB) 110, an image-processing-apparatus information collection module 115, an image-processing-apparatus counter collection module 120, an image-processing-apparatus information matching module 125, a display module 130, and an information transmission module 135.

The image-processing-apparatus registration management module 105 is connected to the image processing apparatus DB 110 and the image-processing-apparatus information matching module 125, and is also connected to the image processing apparatuses 190 via communication lines 290. The image-processing-apparatus registration management module 105 receives information regarding the image processing apparatuses 190, the information being transmitted from the image processing apparatuses 190, and registers the information in the image processing apparatus DB 110. The image-processing-apparatus registration management module 105 receives, for example, machine numbers (information used to uniquely identify the image processing apparatuses 190 in the present exemplary embodiment) and addresses (IP addresses or the like) of the image processing apparatuses 190.

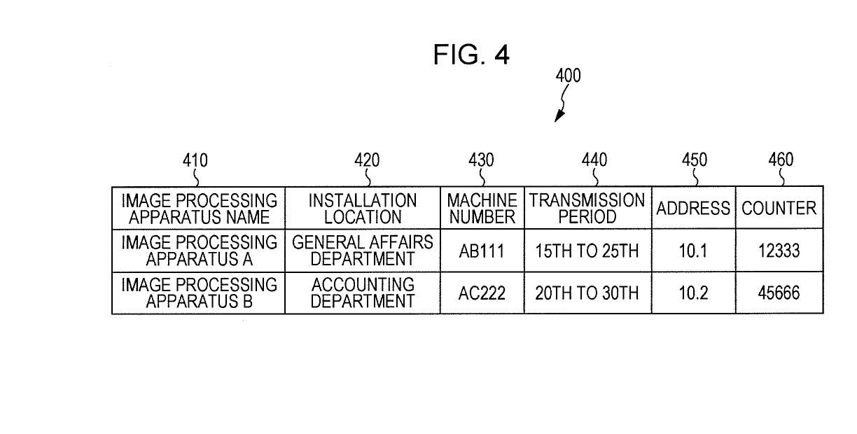

The image processing apparatus DB 110 is connected to the image-processing-apparatus registration management module 105, the image-processing-apparatus information collection module 115, the image-processing-apparatus counter collection module 120, the image-processing-apparatus information matching module 125, the display module 130, and the information transmission module 135. The image processing apparatus DB 110 stores information received by the image-processing-apparatus registration management module 105, the image-processing-apparatus information collection module 115, and the image-processing-apparatus counter collection module 120. The image processing apparatus DB 110 stores, for example, an image processing apparatus table 400. FIG. 4 is a diagram illustrating and for describing an example of a data structure of the image processing apparatus table 400. The image processing apparatus table 400 includes multiple rows, and each row includes an image-processing-apparatus name field 410, an installation location field 420, a machine number field 430, a transmission period field 440, an address field 450, and a counter field 460. For each row, the image-processing-apparatus name field 410 stores a name of an image processing apparatus 190 corresponding to the row. The installation location field 420 in the row stores the location where the image processing apparatus 190 is installed. The machine number field 430 in the row stores the machine number of the image processing apparatuses 190. The transmission period field 440 in the row stores a transmission period for transmitting the counter information regarding the image processing apparatuses 190 to the information collection server 180. These transmission periods stored in the transmission period fields 440 are predetermined for the respective image processing apparatuses 190. The address field 450 in the row stores the address of the image processing apparatus 190. The counter field 460 in the row stores the counter information regarding the image processing apparatus 190. The information in the image-processing-apparatus name field 410, the installation location field 420, the machine number field 430, and the transmission period field 440 is information transmitted from the information collection server 180. The information in the machine number field 430, the address field 450, and the counter field 460 is information transmitted from the image processing apparatus 190. The information transmitted from the information collection server 180 and the information transmitted from the image processing apparatus 190 are stored in a row whose machine number field 430 stores information that matches the information transmitted from the information collection server 180 and the information transmitted from the image processing apparatus 190.

The image-processing-apparatus information collection module 115 is connected to the image processing apparatus DB 110 and the image-processing-apparatus information matching module 125, and is also connected to the information collection server 180 via the communication lines 290. The image-processing-apparatus information collection module 115 acquires, from the information collection server 180, information regarding image processing apparatuses 190 from which use information needs to be collected. For example, information such as the machine numbers, installation locations, and the like of the image processing apparatuses 190 is collected.

The image-processing-apparatus counter collection module 120 is connected to the image processing apparatus DB 110, and is also connected to the image processing apparatuses 190 via the communication lines 290. The image-processing-apparatus counter collection module 120 collects use information for billing from multiple image processing apparatuses 190.

The image-processing-apparatus information matching module 125 is connected to the image-processing-apparatus registration management module 105, the image processing apparatus DB 110, and the image-processing-apparatus information collection module 115. The image-processing-apparatus information matching module 125 registers, in the image processing apparatus DB 110, information regarding each image processing apparatus 190 for which the information collected by the image-processing-apparatus registration management module 105 from the image processing apparatus 190 matches certain information acquired by the image-processing-apparatus information collection module 115 from the information collection server 180.

The display module 130 is connected to the image processing apparatus DB 110. The display module 130 displays the information and use information regarding the image processing apparatuses 190 on a display device such as a liquid crystal display of the information processing apparatus 100.

The display module 130 may display, about certain image processing apparatuses 190 of which an operator is in charge, approval as a preset value. Here, the operator is a person operating the information processing apparatus 100, and is a person in charge of the certain image processing apparatuses 190.

In addition, the display module 130 may display, about image processing apparatuses of which the operator is not in charge, non-approval as a preset value.

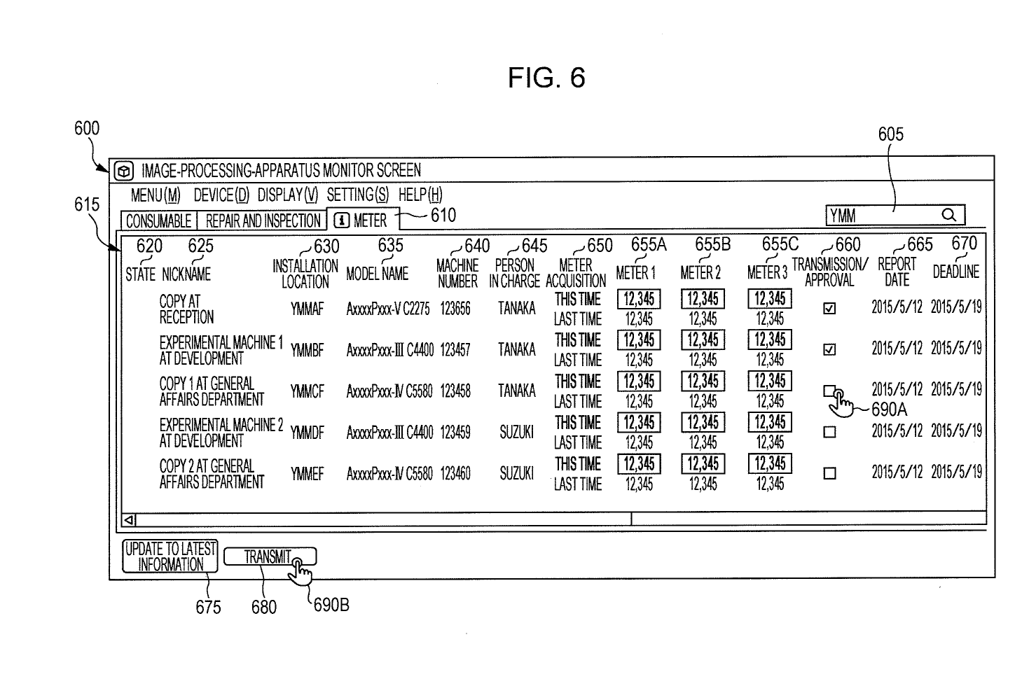

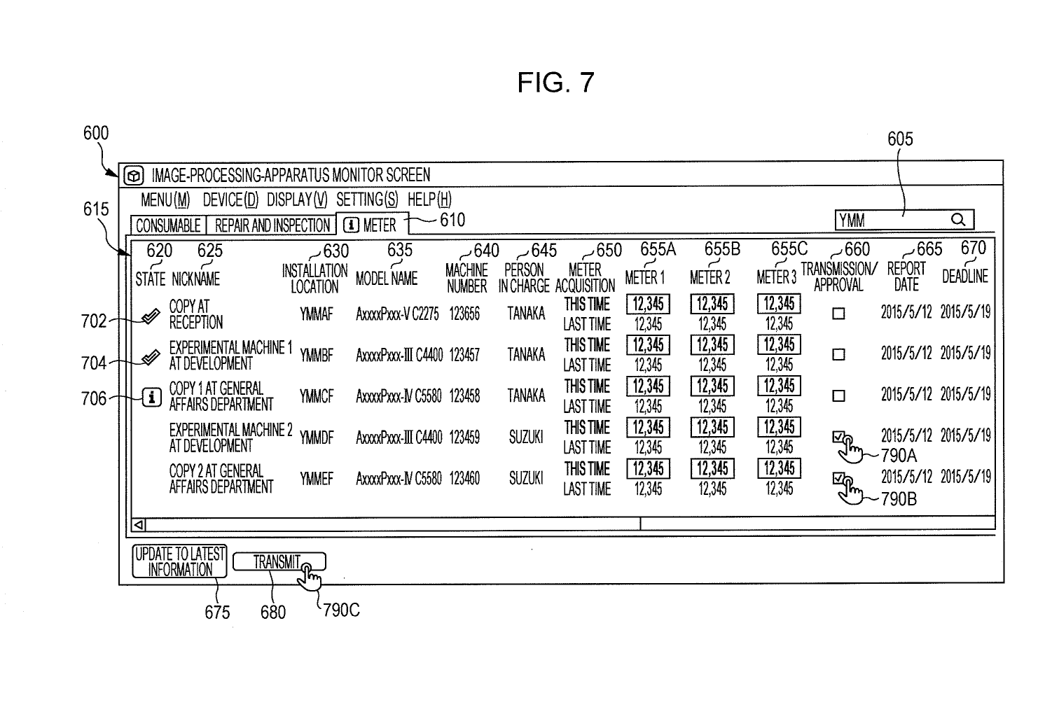

The content of display performed by the display module 130 will be specifically described later using FIGS. 6 and 7 and the like.

The information transmission module 135 is connected to the image processing apparatus DB 110, and is also connected to the information collection server 180 via the communication lines 290. The information transmission module 135 transmits, to the information collection server 180, the use information in accordance with an approval operation regarding the use information.

In addition, the information transmission module 135 may transmits, in the case of non-approval, a message indicating non-approval, and the use information to the information collection server 180.

The information collection server 180 is connected to the image-processing-apparatus information collection module 115 and the information transmission module 135 via the communication lines 290.

The image processing apparatuses 190 are connected to the image-processing-apparatus registration management module 105 and the image-processing-apparatus counter collection module 120 via the communication lines 290.

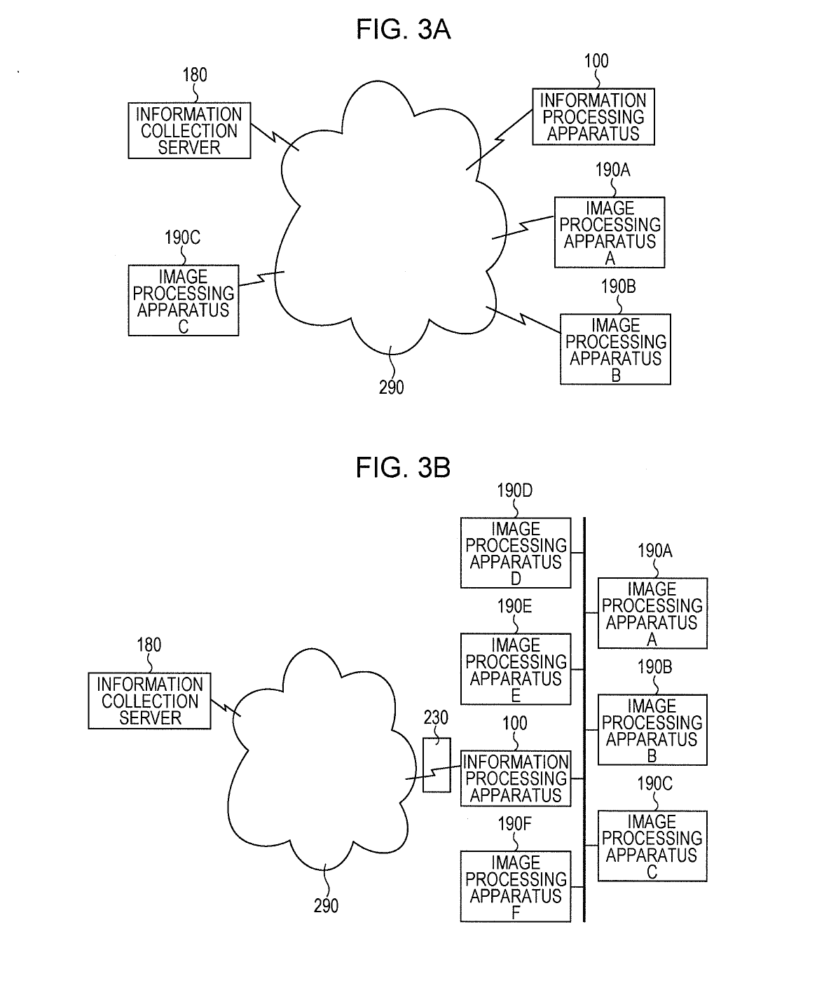

FIGS. 3A and 3B are diagrams illustrating and for describing examples of the system configuration using the present exemplary embodiment.

In the example of FIG. 3A, the information processing apparatus 100, the information collection server 180, and the multiple image processing apparatuses 190 (an image processing apparatus A: 190A, an image processing apparatus B: 190B, and an image processing apparatus C: 190C in this example) are connected to each other via the communication lines 290. The communication lines 290 may be wireless lines, wired lines, or a combination of wireless and wired lines, and may also be for example the Internet or an intranet as a communication infrastructure. In addition, the function of the information collection server 180 may be realized as a cloud service.

In the example of FIG. 3B, the information processing apparatus 100 and the multiple image processing apparatuses 190 (the image processing apparatus A: 190A, the image processing apparatus B: 190B, the image processing apparatus C: 190C, an image processing apparatus D: 190D, an image processing apparatus E: 190E, and an image processing apparatus F: 190F in this example) are connected to each other via the communication lines 290.

The information processing apparatus 100 and the information collection server 180 are connected to each other via the communication lines 290 and a firewall 230. For example, in the case where an intranet connects the information processing apparatus 100 and the image processing apparatuses 190, and the communication lines 290 are the Internet, the firewall 230 is installed. That is, the information processing apparatus 100 and the image processing apparatuses 190 are placed inside the firewall 230, and the information collection server 180 is placed outside the firewall 230 such that communication is not allowed from the information collection server 180 to the information processing apparatus 100 when communication is not performed from the information processing apparatus 100 to the information collection server 180. In the case of such an embodiment, in a transmission process for the counter information regarding the image processing apparatuses 190, a request from the information collection server 180 to the information processing apparatus 100 is not treated as a trigger but transmission from the information processing apparatus 100 to the information collection server 180 is treated as a trigger.

In addition, these image processing apparatuses 190 are not of the same model (these image processing apparatuses 190 including multiple models). Since implementation periods and types of contract of the image processing apparatuses 190 are also different, counter-information transmission periods may be different. Furthermore, since there are multiple image processing apparatuses 190, multiple persons may also often be in charge. The information processing apparatus 100 is especially appropriate for such a situation.

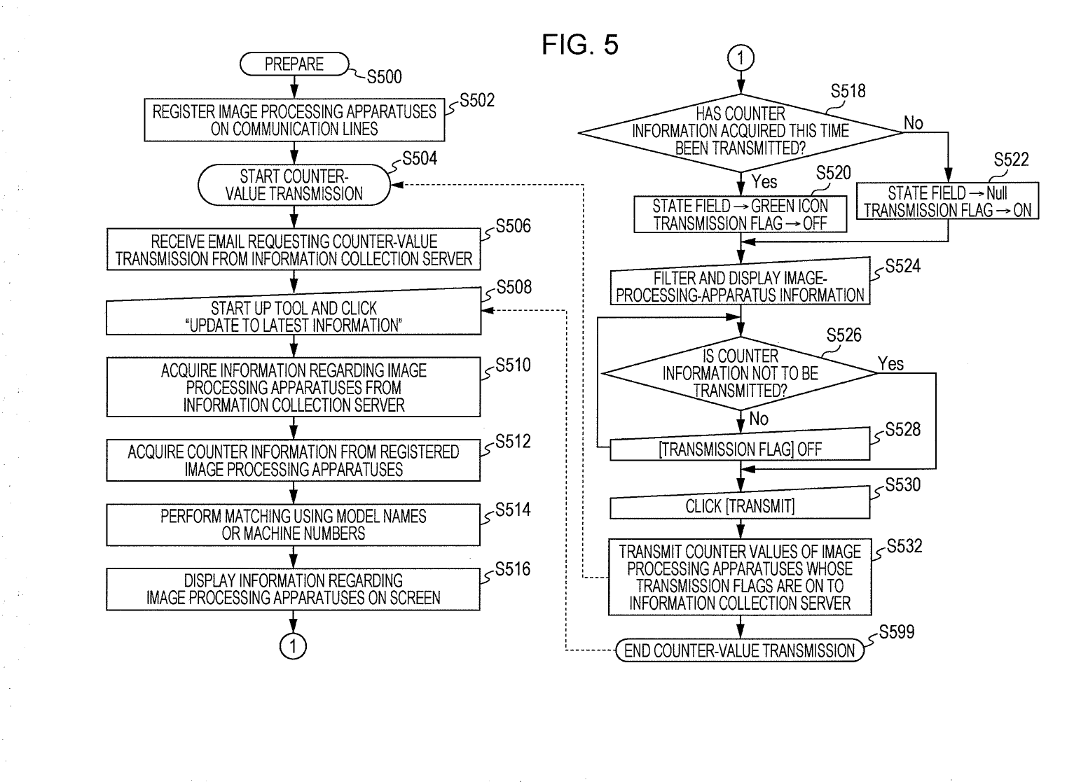

FIG. 5 is a flowchart illustrating an example of a process according to the first exemplary embodiment.

In Step S500, advance preparations are made.

In Step S502, the image processing apparatuses 190 on the communication lines 290 are registered. For example, as registration information, an IP address, a model machine number, and the like are acquired from each of the image processing apparatuses 190, and are registered. Note that this process is performed once after each installation of image processing apparatuses 190.

In Step S504, counter-information transmission is started.

In Step S506, an email that is a request for transmission of counter information is received from the information collection server 180. Note that even in the case where the firewall 230 is installed as illustrated in the example of FIG. 3B, an email from the information collection server 180 to the information processing apparatus 100 is not directly transmitted from the information collection server 180 to the information processing apparatus 100 but transmitted via a mail server, and transmission of the email is triggered by an email acquisition command issued from the information processing apparatus 100.

In Step S508, a tool for performing a process performed by the information processing apparatus 100 is started up, and clicking on an “update to the latest information” button 675 through an operation performed by a user is detected. A specific content of display will be described later using the example of FIG. 6.

In Step S510, information regarding the image processing apparatuses 190 is acquired from the information collection server 180.

In Step S512, counter information is acquired from the registered image processing apparatuses 190.

In Step S514, matching is performed using model names or machine numbers. That is, matching is performed between the image processing apparatuses 190, the information regarding the image processing apparatuses 190 being acquired from the information collection server 180, and the registered image processing apparatuses 190.

In Step S516, the information regarding the image processing apparatuses 190 is displayed on the screen. The counter information acquired from the image processing apparatuses 190 is displayed on the information regarding the image processing apparatuses 190 acquired from the information collection server 180.

In Step S518, it is determined whether the counter information acquired this time has been transmitted. In the case where it is determined that the counter information acquired this time has been transmitted, the process proceeds to Step S520. Otherwise, the process proceeds to Step S522. In this process, this determination is made on the basis of the information regarding the image processing apparatuses 190 acquired from the information collection server 180.

In Step S520, for each image processing apparatus 190, a green icon is displayed in a state field 620 corresponding to the image processing apparatus 190, and a transmission flag is set to OFF.

In Step S522, for each image processing apparatus 190, the state field 620 corresponding to the image processing apparatus 190 is set to Null, and the transmission flag is set to ON.

In Step S524, filtering processing is performed on image-processing-apparatus information displayed in an image-processing-apparatus meter-related information table 615. That is, image processing apparatuses 190 to be displayed are narrowed down by filtering the image-processing-apparatus information and displaying the resulting information in accordance with an operation performed by the operator.

In Step S526, it is determined whether the operator does not transmit the counter information. In the case where it is determined that the operator does not transmit the counter information, the process proceeds to Step S528. Otherwise, the process proceeds to Step S530. Such a determination is made for all the image processing apparatuses 190.

In Step S528, OFFs in check boxes in the transmission/approval fields 660 are detected.

In Step S530, clicking on a “transmit” button 680 is detected.

In Step S532, the counter information regarding image processing apparatuses 190 having ON in the check boxes in the transmission/approval fields 660 is transmitted to the information collection server 180.

In Step S599, transmission of the counter information ends.

FIG. 6 is a diagram illustrating and for describing an example of a process according to the first exemplary embodiment.

In Step S516, for example, an image-processing-apparatus monitor screen 600 is displayed. A filtering-use box 605, a consumable tab, a repair-and-inspection tab, and a meter tab 610 are displayed in the image-processing-apparatus monitor screen 600. In the case where the meter tab 610 is selected through an operation performed by a user, the image-processing-apparatus meter-related information table 615, the “update to the latest information” button 675, and the “transmit” button 680 are displayed in the image-processing-apparatus monitor screen 600.

The image-processing-apparatus meter-related information table 615 includes multiple rows, and each row includes the state field 620, a nickname field 625, an installation location field 630, a model name field 635, a machine number field 640, a person-in-charge field 645, a meter acquisition field 650, a meter-1 field 655A, a meter-2 field 655B, a meter-3 field 655C, the transmission/approval field 660, a report date field 665, and a deadline field 670. In an initial state, nothing is displayed in the image-processing-apparatus meter-related information table 615, that is, the image-processing-apparatus meter-related information table 615 is blank. In the case where the “update to the latest information” button 675 is selected, display is performed. That is, information regarding multiple target image processing apparatuses 190 (for example, names, installation locations, model names, machine numbers, persons in charge, counter information acquired last time, counter information acquired this time (for example, 0 in the case where transmission has not been performed) is acquired from the information collection server 180 and displayed.

Machine numbers and counter information are acquired from the multiple image processing apparatuses 190, and matching is performed between the machine numbers acquired from the multiple image processing apparatuses 190 and the machine numbers acquired from the information collection server 180. Thereafter, the information acquired from the information collection server 180 and the counter information acquired from the image processing apparatuses 190 are combined and then displayed in the meter fields 655. Conventional processing is performed in the image processing apparatuses 190.

For each row, the state field 620 displays a transmission state of the counter information regarding an image processing apparatus 190 corresponding to the row. The nickname field 625 in the row displays a name (nickname) of the image processing apparatus 190. The installation location field 630 in the row displays the location where the image processing apparatus 190 is installed. The model name field 635 in the row displays a model name of the image processing apparatus 190. The machine number field 640 in the row displays a machine number of the image processing apparatus 190. The person-in-charge field 645 in the row displays a person in charge of the image processing apparatus 190. The meter acquisition field 650, the meter-1 field 655A, the meter-2 field 655B, and the meter-3 field 655C in the row each display counter information regarding the image processing apparatus 190 acquired last time and this time separately. The meter-1 field 655A and the like display, for example, the number of color-printed sheets, the number of monochrome-printed sheets, and the number of color copies. The transmission/approval field 660 in the row has a check box for specifying whether to transmit or approve the counter information regarding the image processing apparatus 190. For example, an approval operation corresponds to setting of a check in this check box and selecting of the “transmit” button 680. The report date field 665 in the row displays a date at which the counter information regarding the image processing apparatus 190 is reported (transmitted). The deadline field 670 in the row displays a deadline for transmission of the counter information regarding the image processing apparatus 190.

The filtering-use box 605 is used to perform filtering on information (for example, installation locations or the like) regarding the image processing apparatuses 190 and to display the resulting information. That is, a search for image processing apparatuses 190 matching text written in the filtering-use box 605 is made.

In the case where, in a transmission performed this time, there are image processing apparatuses 190 for which counter information has not been transmitted, the meter tab 610 and the image-processing-apparatus meter-related information table 615 display a non-transmission state. In the case where multiple persons in charge manage multiple image processing apparatuses 190, when a certain person in charge is accepted through the filtering-use box 605, the multiple image processing apparatuses 190 are narrowed down and the image processing apparatuses 190 corresponding to the person in charge are displayed. In addition, in the case where narrowing down is not performed in accordance with a certain person in charge, even when the counter information regarding the image processing apparatuses 190 corresponding to the person in charge has been transmitted, image processing apparatuses 190 that do not correspond to the person in charge and for which counter information has not been transmitted may be displayed if there are any such image processing apparatuses 190.

The person-in-charge field 645 in the row displays person-in-charge information regarding the image processing apparatus 190. In the case where the person in charge of the image processing apparatus 190 is the operator (himself or herself), a check is automatically set in the check box in the transmission/approval field 660.

In addition, for example, in the case where another person in charge has not performed a certain transmission, the operator may perform the transmission on behalf of the other person in charge. Specifically, in the case where a system is employed in which a main person and a sub-person are in charge and where the main person in charge has not performed a certain transmission, the sub-person in charge may perform the transmission on behalf of the main person.

The transmission flag in each transmission/approval field 660 may be switched between ON and OFF (manually) through an operation performed by a user. In the case where the counter information has been transmitted, the transmission flag is automatically set to OFF (indicating that transmission is unnecessary), and in the case where the counter information has not been transmitted, the transmission flag is automatically set to ON (indicating that transmission is necessary). In the case where approval has not been given, the transmission flag is set to OFF through an operation performed by a user, and thus the counter information is not transmitted.

In the case where the “transmit” button 680 is selected through an operation performed by a user, the counter information regarding image processing apparatuses 190 whose transmission flags are set to ON is collectively transmitted to the information collection server 180. That is, a transmission (approval) action is done in one operation. In addition, even when counter-information transmission periods for the respective image processing apparatuses 190 are not the same, a transmission (approval) action is done in one operation. For example, even when a transmission period for some of the image processing apparatuses 190 is from 15th to 25th every month and a transmission period for some of the image processing apparatuses 190 is from 20th to 30th every month, batch transmission is possible from 20th to 25th.

The following is illustrated in the example of FIG. 6.

A check is automatically set in the check boxes in the transmission/approval fields 660 for image processing apparatuses 190 of which an operator (Tanaka) of the information processing apparatus 100 is in charge. Specifically, in an initial state, a check is set in the first, second, and third rows in the image-processing-apparatus meter-related information table 615.

In the case where approval has not been given to the counter information regarding the image processing apparatus 190 corresponding to the third row in the image-processing-apparatus meter-related information table 615, the check is removed using a pointer 690A. When the “transmit” button 680 is clicked using a pointer 690B, the counter information regarding the image processing apparatuses 190 corresponding to the first and second rows in the image-processing-apparatus meter-related information table 615 is transmitted to the information collection server 180.

FIG. 7 is a diagram illustrating and for describing an example of the process according to the first exemplary embodiment.

In the example of FIG. 6, when the tool is started up for the second time after the “transmit” button 680 is selected, the state fields 620 for the image processing apparatuses 190 for which the counter information has been transmitted display a state display icon (transmitted) 702 and a state display icon (transmitted) 704, and the state field 620 for the image processing apparatus 190 for which the counter information has not been transmitted displays a state display icon (not transmitted) 706. That is, the state fields 620 for the image processing apparatuses 190 for which the counter information acquired this time has been transmitted display an icon indicating that transmission has been performed. The state field 620 for the image processing apparatus 190 to which approval has not been given last time displays an icon indicating that approval has not been given.

In the case where the operator gives approval and performs transmission on behalf of another person in charge (Suzuki), the operator manually sets a check in the check boxes in certain transmission/approval fields 660. Specifically, a check is set in the fourth and fifth rows in the image-processing-apparatus meter-related information table 615 using a pointer 790A and a pointer 790B, and the “transmit” button 680 is selected using a pointer 790C.

### Second Exemplary Embodiment

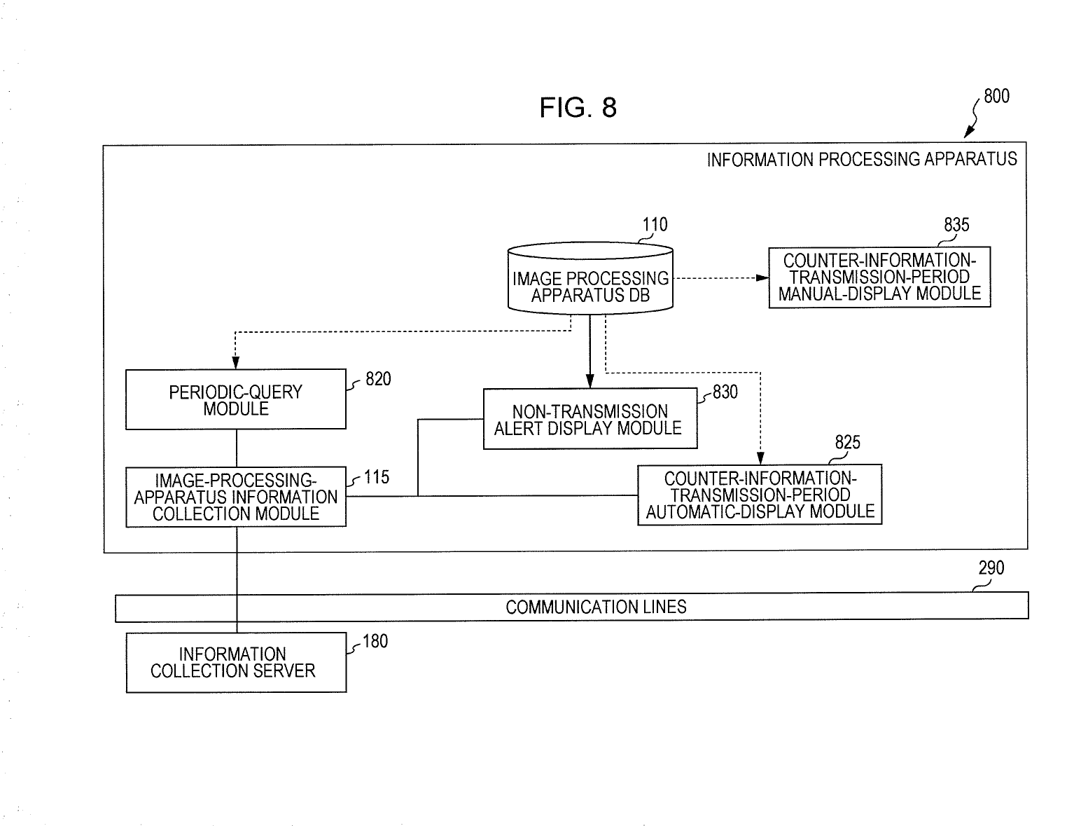

FIG. 8 illustrates a diagram of a conceptual module configuration about an example of the configuration of a second exemplary embodiment.

An information processing apparatus 800 includes the image processing apparatus DB 110, the image-processing-apparatus information collection module 115, a periodic-query module 820, a counter-information-transmission-period automatic-display module 825, a non-transmission alert display module 830, and a counter-information-transmission-period manual-display module 835. The information processing apparatus 800 has the function of preventing incomplete approval. Note that the portions that are the same type as those of the first exemplary embodiment are denoted by the same reference numerals, and redundant description thereof will be omitted.

The image processing apparatus DB 110 is connected to the periodic-query module 820, the counter-information-transmission-period automatic-display module 825, the non-transmission alert display module 830, and the counter-information-transmission-period manual-display module 835.

The image-processing-apparatus information collection module 115 is connected to the periodic-query module 820, the counter-information-transmission-period automatic-display module 825, and the non-transmission alert display module 830, and is also connected to the information collection server 180 via the communication lines 290.

The information collection server 180 is connected to the image-processing-apparatus information collection module 115 via the communication lines 290.

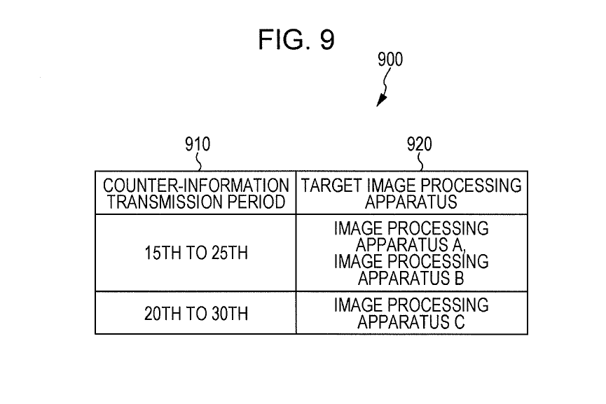

The periodic-query module 820 is connected to the image processing apparatus DB 110 and the image-processing-apparatus information collection module 115. The periodic-query module 820 periodically poses, to the information collection server 180, a query about information regarding image processing apparatuses 190, and may display the image-processing-apparatus monitor screen 600 described above. Note that, here, periodic queries may be posed at predetermined time intervals or at timings at which a login is performed to the information processing apparatus 800, and may also be posed using a transmission period table 900. FIG. 9 is a diagram illustrating and for describing an example of a data structure of the transmission period table 900. Note that the transmission period table 900 may be acquired from the information collection server 180 and stored in the image processing apparatus DB 110. The transmission period table 900 includes a counter-information transmission period column 910 and a target image processing apparatus column 920. The counter-information transmission period column 910 stores counter-information transmission periods. The target image processing apparatus column 920 stores image processing apparatuses 190 to which the transmission periods are applied. When a certain period included in the counter-information transmission period column 910 comes, a query is posed to the information collection server 180, and information for displaying the image-processing-apparatus monitor screen 600 described above or the like is acquired. In addition, when a certain period included in the counter-information transmission period column 910 of the transmission period table 900 comes, the non-transmission alert display module 830 may perform display indicating that the period has come. For example, a visual notification (such as an icon or a pop-up) may be made.

The counter-information-transmission-period automatic-display module 825 is connected to the image processing apparatus DB 110 and the image-processing-apparatus information collection module 115. When display is performed by the non-transmission alert display module 830, the counter-information-transmission-period automatic-display module 825 displays a counter-information transmission period and a counter-information transmission period that is outside the notification period targeted this time.

The counter-information-transmission-period manual-display module 835 is connected to the image processing apparatus DB 110. The counter-information-transmission-period manual-display module 835 displays, in accordance with an operation performed by the operator, a counter-information transmission period and a counter-information transmission period that is outside the notification period targeted this time.

The non-transmission alert display module 830 is connected to the image processing apparatus DB 110 and the image-processing-apparatus information collection module 115. In the case where the current time is in a period that is set for an image processing apparatus 190 among periods set for the image processing apparatuses 190 on an image processing apparatus basis and which is for transmitting use information regarding the image processing apparatus 190 to the information collection server 180, the non-transmission alert display module 830 may perform, after the person in charge of the image processing apparatus 190 logs in to the information processing apparatus 800, display indicating that the current time is in the period for transmitting the use information regarding the image processing apparatus 190.

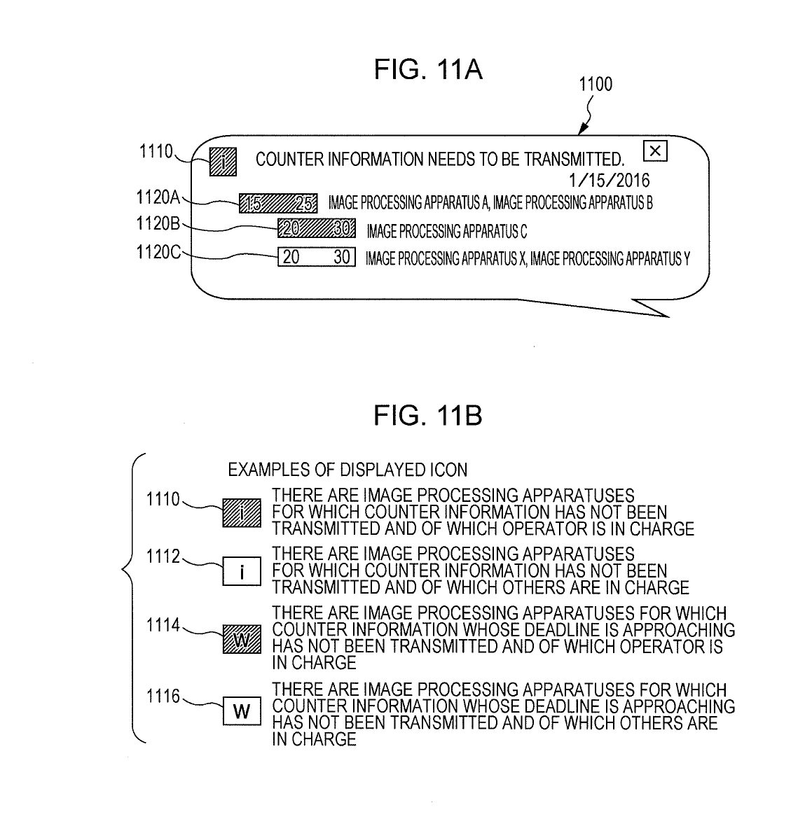

In the case where there are image processing apparatuses 190 for which counter information has not been transmitted (for which approval has not been given), a visual notification (such as an icon or a pop-up) is made. Furthermore, display may be performed such that image processing apparatuses 190 of which the operator is in charge are distinguished from those of which others are in charge. For example, display may be performed in a color-coded manner such that display is performed in yellow in the case where there are image processing apparatuses 190 of which the operator is in charge and for which counter information has not been transmitted, and display is performed in light blue in the case where there are image processing apparatuses 190 of which others are in charge and for which counter information has not been transmitted. Color coding is an example, and display may also be performed such that the image processing apparatuses 190 of which the operator is in charge are distinguished from those of which the others are in charge by using, for example, certain text, a certain shape, or a certain pattern, in a certain size or in a blinking manner, or a combination of some or all of them. For example, a visual notification (such as an icon or a pop-up) may be made as in, for example, alert display 1100 illustrated in FIG. 11 to be described later.

In addition, in the case where there are image processing apparatuses 190 for which counter information has not been transmitted (for which approval has not been given) and where the deadline for transmission of the counter information is approaching, the non-transmission alert display module 830 may change display of a notification. Note that, here, “the case where the deadline is approaching” means that the current time is within a predetermined period before the last day of the transmission period. For example, display performed in a non-blinking manner is changed to display performed in a blinking manner, text display indicating “attention”, or the like. This is performed to certainly prevent performing of transmission (giving of approval) from being forgotten.

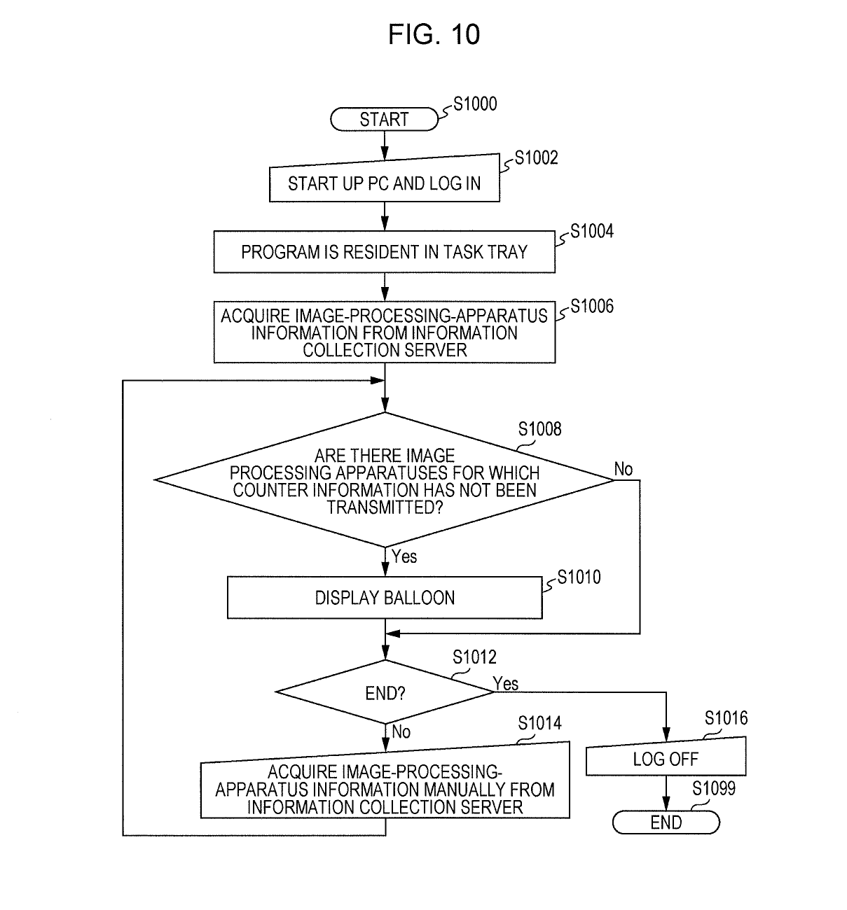

FIG. 10 is a flowchart illustrating an example of a process according to the second exemplary embodiment.

In Step S1002, the information processing apparatus 800 (PC) is started up and a login is performed in accordance with an operation performed by the operator.

In Step S1004, a program having the function of the information processing apparatus 800 is resident in a task tray.

In Step S1006, information regarding image processing apparatuses 190 is acquired from the information collection server 180. In the case where automatic acquisition from the information collection server 180 is unable to be performed, the information may also be acquired from the image processing apparatus DB 110.

In Step S1008, it is determined whether there are image processing apparatuses 190 for which counter information has not been transmitted. In the case where there are image processing apparatuses 190 for which counter information has not been transmitted, the process proceeds to Step S1010. Otherwise, the process proceeds to Step S1012.

In Step S1010, a balloon is displayed. Displayed contents of the balloon are illustrated in the example of FIG. 11A.

In Step S1012, it is determined whether the process ends. In the case where the process ends, the process proceeds to Step S1016. Otherwise, the process proceeds to Step S1014.

In Step S1014, the counter-information-transmission-period manual-display module 835 acquires, from the information collection server 180, information regarding the image processing apparatuses 190 (manually) in accordance with an operation performed by the operator. Details have already been described in the flowchart illustrated in the example of FIG. 5.

In Step S1016, a log-off is performed in accordance with an operation performed by the operator.

FIGS. 11A and 11B are illustrating and diagrams for describing an example of a process according to the second exemplary embodiment. The alert display 1100 illustrated in the example of FIG. 11A is displayed through processing performed by the non-transmission alert display module 830 and the counter-information-transmission-period automatic-display module 825. The alert display 1100 is an example of alert display indicating that counter information has not been transmitted. When the information processing apparatus 800 is started up, in the case where there are image processing apparatuses 190 for which counter information has not been transmitted in the counter-information transmission periods (the counter-information transmission period column 910 of the transmission period table 900), the alert display 1100 is displayed. The alert display 1100 may be, for example, displayed as a balloon. The image-processing-apparatus monitor screen 600 may also be displayed upon detection of clicking on the alert display 1100.

For example, an alert icon 1110 and “counter information needs to be transmitted. 1/15/2016” are displayed in the alert display 1100. Transmission periods are illustrated using a transmission-period display icon 1120A and the like. For each transmission period, image processing apparatuses 190 for which counter information needs to be transmitted during the transmission period are displayed so as to be associated with the transmission period. For example, the transmission-period display icon 1120A, which is a hatched icon, indicates that counter information needs to be transmitted from 15th to 25th, and “there are image processing apparatuses for which counter information has not been transmitted and of which the operator is in charge”. As image processing apparatuses 190 corresponding to this “there are image processing apparatuses for which counter information has not been transmitted and of which the operator is in charge”, an image processing apparatus A and an image processing apparatus B are illustrated. In addition, a transmission-period display icon 1120B, which is a hatched icon, indicates that counter information needs to be transmitted from 20th to 30th, and “there are image processing apparatuses for which counter information has not been transmitted and of which the operator is in charge”. As image processing apparatuses 190 corresponding to this “there are image processing apparatuses for which counter information has not been transmitted and of which the operator is in charge”, an image processing apparatus C is illustrated. A transmission-period display icon 1120C, which is not a hatched icon, indicates that counter information needs to be transmitted from 20th to 30th, and “there are image processing apparatuses for which counter information has not been transmitted and of which others are in charge”. As image processing apparatuses 190 corresponding to this “there are image processing apparatuses for which counter information has not been transmitted and of which others are in charge”, an image processing apparatus X and an image processing apparatus Y are illustrated.

Note that as an alert icon displayed at the upper left portion within the alert display 1100, there are four types of icon illustrated in the example of FIG. 11B. The alert icon 1110 is displayed in the case where “there are image processing apparatuses for which counter information has not been transmitted and of which the operator is in charge”. An alert icon 1112 is displayed in the case where “there are image processing apparatuses for which counter information has not been transmitted and of which others are in charge”. An alert icon 1114 is displayed in the case where “there are image processing apparatuses for which counter information whose deadline is approaching has not been transmitted and of which the operator is in charge”. An alert icon 1116 is displayed in the case where “there are image processing apparatuses for which counter information whose deadline is approaching has not been transmitted and of which others are in charge”.

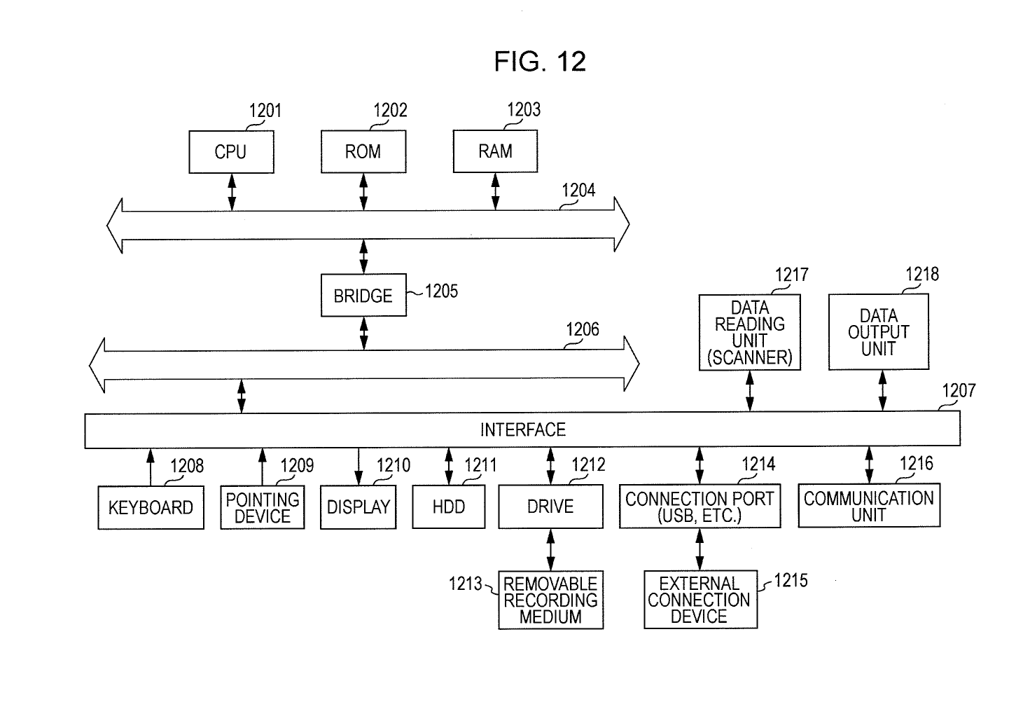

An example of a hardware configuration of an information processing apparatus according to the present exemplary embodiments (the information processing apparatus 100 and the information processing apparatus 800) will be described with reference to FIG. 12. The configuration illustrated in FIG. 12 is realized, for example, using a personal computer (PC) or the like, and the example of the hardware configuration includes a data reading unit 1217 such as a scanner and a data output unit 1218 such as a printer.

A central processing unit (CPU) 1201 is a controller that executes processing in accordance with a computer program in which the execution sequence of various modules described in the above-described exemplary embodiments is described. The various modules are the image-processing-apparatus registration management module 105, the image-processing-apparatus information collection module 115, the image-processing-apparatus counter collection module 120, the image-processing-apparatus information matching module 125, the display module 130, the information transmission module 135, the periodic-query module 820, the counter-information-transmission-period automatic-display module 825, the non-transmission alert display module 830, the counter-information-transmission-period manual-display module 835, and the like.

A read-only memory (ROM) 1202 stores programs, calculation parameters, and the like used by the CPU 1201. A random-access memory (RAM) 1203 stores programs used during execution of the CPU 1201, parameters that change as appropriate during the execution, and the like. The CPU 1201, the ROM 1202, and the RAM 1203 are connected to one another by a host bus 1204, which includes a CPU bus and the like.

The host bus 1204 is connected to an external bus 1206 such as a Peripheral Component Interconnect/Interface (PCI) bus via a bridge 1205.

A keyboard 1208 and a pointing device 1209 such as a mouse are devices operated by an operator. A display 1210 is, for example, a liquid crystal display device or a cathode ray tube (CRT), and displays various types of information as text information or image information. A touch screen or the like having both the function of the pointing device 1209 and the function of the display 1210 may also be used.

A hard disk drive (HDD) 1211 includes a hard disk (which may also be a flash memory or the like), drives the hard disk, and causes the hard disk to record or play back a program or information executed by the CPU 1201. The hard disk realizes a function as the image processing apparatus DB 110 or the like. Furthermore, various other types of data, various other computer programs, and the like are stored.

A drive 1212 reads out data or a program recorded in a removable recording medium 1213, which is inserted into the drive 1212, and supplies the data or program to the RAM 1203, which is connected to the drive 1212 via an interface 1207, the external bus 1206, the bridge 1205, and the host bus 1204. The removable recording medium 1213 is a magnetic disk, an optical disc, a magneto-optical disk, a semiconductor memory, or the like. Note that the removable recording medium 1213 is also usable as a data recording region.

A connection port 1214 is a port for connecting an external connection device 1215, and includes connectors for USB, IEEE 1394, and the like. The connection port 1214 is connected to the CPU 1201 and the like via the interface 1207, the external bus 1206, the bridge 1205, the host bus 1204, and the like. A communication unit 1216 is connected to a communication line and executes a process for data communication to and from the outside. The data reading unit 1217 is, for example, a scanner, and executes a document reading process. The data output unit 1218 is, for example, a printer, and executes a document data output process.

Note that the hardware configuration of the information processing apparatus illustrated in FIG. 12 is an exemplary configuration. The configuration of the present exemplary embodiment is not limited to the configuration illustrated in FIG. 12, and has only to be a configuration with which the modules described in the present exemplary embodiments are executable. For example, some of the modules may be constituted by a dedicated hardware device (for example, an application specific integrated circuit (ASIC), which is an integrated circuit for a specific use, or the like). Some of the modules may be provided in an external system and connected through communication lines. Furthermore, multiple systems each of which is illustrated in FIG. 12 may be connected to each other through communication lines and may operate in a cooperative manner. In addition, in particular, the hardware configuration of the information processing apparatus may also be installed in mobile information communication devices (including mobile phones, smartphones, mobile devices, wearable computers, and the like), information home appliances, robots, copiers, faxes, scanners, printers, multifunction machines, and the like in addition to personal computers.

Note that the above-described various types of exemplary embodiment may also be combined (which includes for example the case where a module in a certain exemplary embodiment is added to another exemplary embodiment, the case where a module in the certain exemplary embodiment and a module in the other exemplary embodiment are switched, and the like). In addition, as the processing content of each module, a technique described in the background may also be employed.

Note that the program that has been described may also be stored in a recording medium and provided. Furthermore, the program may also be provided through a communication unit. In that case, for example, the program described above may also be considered as an invention that is a “computer readable recording medium in which a program is recorded”.

The “computer readable recording medium in which a program is recorded” is a computer readable recording medium used for installation, execution, distribution, and the like of the program and in which the program is recorded.

Note that examples of the recording medium include a digital versatile disc (DVD), a compact disc (CD), a Blu-ray disc (Blu-ray® Disc), a magneto-optical disk (MO), a flexible disk (FD), a magnetic tape, a hard disk, a read-only memory (ROM), an electrically erasable programmable ROM (EEPROM®), a flash memory, a random access memory (RAM), an SD (Secure Digital) memory card, and the like. DVDs include “a DVD-R, a DVD-RW, a DVD-RAM, and the like” for standards developed by the DVD forum and “a DVD+R, a DVD+RW, and the like” for standards developed by DVD+RW. CDs include a compact disc-read-only memory (CD-ROM), a CD recordable (CD-R), a CD-Rewritable (CD-RW), and the like.

The above-described program or a portion of the program may also be recorded and saved in the above-described recording medium, distributed, or the like. The above-described program or the portion of the program may also be transmitted through communication, for example, through a wired network, a wireless communication network, or a transmission medium such as a combination of a wired network and a wireless communication network or the like. The wired network is used in a local-area network (LAN), a Metropolitan Area Network (MAN), a wide area network (WAN), the Internet, an intranet, an extranet, and the like. Alternatively, the above-described program or the portion of the program may also be transferred by a carrier wave.

Furthermore, the above-described program may also be a portion or the entirety of another program or may also be recorded in a recording medium together with a separate program. In addition, the above-described program may also be divided and recorded in multiple recording mediums. In addition, the above-described program may also be recorded in any format such as a compressed format, an encrypted format, or the like, as long as the above-described program is reconstructable.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires, from an information collection apparatus, information regarding a plurality of image processing apparatuses from which use information needs to be collected;
a collecting unit that collects use information for billing from the plurality of image processing apparatuses; and
a transmitting unit that transmits, to the information collection apparatus, the use information in accordance with an approval operation regarding the use information.

2. The information processing apparatus according to claim 1, further comprising
a display that displays, about an image processing apparatus of which an operator is in charge, approval as a preset value.

3. The information processing apparatus according to claim 2,
wherein the display displays, about an image processing apparatus of which the operator is not in charge, non-approval as a preset value.

4. The information processing apparatus according to claim 1, further comprising
a second display that performs, in the case where a current time is in a period that is set for an information collection apparatus among periods set for the information collection apparatuses on an information collection apparatus basis and which is for transmitting use information regarding the image processing apparatus to the information collection apparatus, display indicating that the current time is in the period for transmitting the use information regarding the image processing apparatus, after a person in charge of the image processing apparatus logs in to the information processing apparatus.

5. The information processing apparatus according to claim 2, further comprising
a second display that performs, in the case where a current time is in a period that is set for an information collection apparatus among periods set for the information collection apparatuses on an information collection apparatus basis and which is for transmitting use information regarding the image processing apparatus to the information collection apparatus, display indicating that the current time is in the period for transmitting the use information regarding the image processing apparatus, after a person in charge of the image processing apparatus logs in to the information processing apparatus.

6. The information processing apparatus according to claim 3, further comprising
a second display that performs, in the case where a current time is in a period that is set for an information collection apparatus among periods set for the information collection apparatuses on an information collection apparatus basis and which is for transmitting use information regarding the image processing apparatus to the information collection apparatus, display indicating that the current time is in the period for transmitting the use information regarding the image processing apparatus, after a person in charge of the image processing apparatus logs in to the information processing apparatus.

7. The information processing apparatus according to claim 1,
wherein the transmitting unit transmits, in a case of non-approval, a message indicating non-approval and the use information to the information collection apparatus.

8. The information processing apparatus according to claim 2,
wherein the transmitting unit transmits, in a case of non-approval, a message indicating non-approval and the use information to the information collection apparatus.

9. The information processing apparatus according to claim 3,
wherein the transmitting unit transmits, in a case of non-approval, a message indicating non-approval and the use information to the information collection apparatus.

10. The information processing apparatus according to claim 4,
wherein the transmitting unit transmits, in a case of non-approval, a message indicating non-approval and the use information to the information collection apparatus.

11. The information processing apparatus according to claim 5,
wherein the transmitting unit transmits, in a case of non-approval, a message indicating non-approval and the use information to the information collection apparatus.

12. The information processing apparatus according to claim 6,
wherein the transmitting unit transmits, in a case of non-approval, a message indicating non-approval and the use information to the information collection apparatus.

13. An image processing method comprising:
acquiring, from an information collection apparatus, information regarding a plurality of image processing apparatuses from which use information needs to be collected;
collecting use information for billing from the plurality of image processing apparatuses; and
transmitting, to the information collection apparatus, the use information in accordance with an approval operation regarding the use information.

14. A non-transitory computer readable medium storing a program causing a computer to execute a process, the process comprising:
acquiring, from an information collection apparatus, information regarding a plurality of image processing apparatuses from which use information needs to be collected;
collecting use information for billing from the plurality of image processing apparatuses; and
transmitting, to the information collection apparatus, the use information in accordance with an approval operation regarding the use information.
